(19) United States
(12) Patent Application Publication
(10) Pub. No.: US 2010/0279258 A1
(43) Pub. Date: Nov. 4, 2010

(54) Kinesthetic Educational Methods and Games

(76) Inventor: Jessica Cohen, Tel Aviv (IL)

Correspondence Address: Jessica Cohen LTD., P.O. Box 35035, Salame Post Office, Tel Aviv, 61350, IL

(21) Appl. No.: 12/754,052

(22) Filed: Apr. 5, 2010

Related U.S. Application Data
(60) Provisional application No. 61/168,630, filed on Apr. 13, 2009.

(51) Int. Cl. G09B 19/22; G09B 19/00; G09B 7/00

(52) U.S. Cl. 434/128; 434/238; 434/362

(57) ABSTRACT

Methods and games for teaching cognitive and social skills to children with alternative learning styles, particularly children with kinesthetic and/or visual learning styles. Mission-oriented exercises are designed to engage hyperactive children to solve problems. Alternative methods of displaying and sequencing data communicate with visual learners, encouraging flexibility of cognitive thought processes.

Various embodiments of games and game parts are disclosed herein. Children are dealt game parts having indicia, such as numbers, letters, or actions. Children configure said parts into linear, curvilinear, radial, or stacked assemblies, producing random, compound permutations of equations to calculate. Children operate the games in a competitive, cooperative social environment. An observer provides feedback. Said games require physical exercise which promotes kinesthetic learning. Said permutations create subgroups of children to interact socially.

The inventor contemplates embodiments as electromechanical games, comprised of substantially smaller, plastic game parts, wherein embedded electronic components display indicia and provide feedback.

### RELATED APPLICATIONS

This application claims the benefit of and incorporates herein by reference for all purposes the entire contents of U.S. Provisional Application No. 61/168,630, and filing date Apr. 13, 2009.

### LIST OF THE DRAWINGS

FIG. 1 shows a flow chart of a kinesthetic educational method described in claim 1;

FIGS. 2, 3, and 4 show top, side, and isometric views of the preferred embodiment of a game part, described in claims 2 and 3, with one hollow core;

FIG. 5 illustrates a game using said parts, described in claim 2;

FIG. 6 illustrates an alternate game, described in claim 3, using said parts;

FIG. 7 shows a top view of the preferred embodiment of a game part, described in claims 2 and 3, with a plurality of hollow cores;

FIG. 8 shows a side view of said embodiment;

FIG. 9 illustrates a game using said parts described in claim 2, and using game parts shown in FIGS. 9 and 10;

FIG. 10 illustrates an alternate game, described in claim 3, and using game parts shown in FIGS. 9 and 8;

FIGS. 11, 12, and 13 show side, top, and isometric views of a radial game part described in claim 4;

FIGS. 14, 15, and 16 show side, top, and isometric views of a complementary satellite game part, described in claim 4;

FIG. 17 illustrates a game, described in claim 4, using the game parts shown in FIGS. 11-16;

FIGS. 18 and 19 illustrate a game, described in claim 5, using the rectilinear and satellite game parts shown FIGS. 11-13, and FIGS. 20-22;

FIGS. 20, 21, and 22 show side, front, and isometric views of a generally rectilinear game part, described in claim 5.

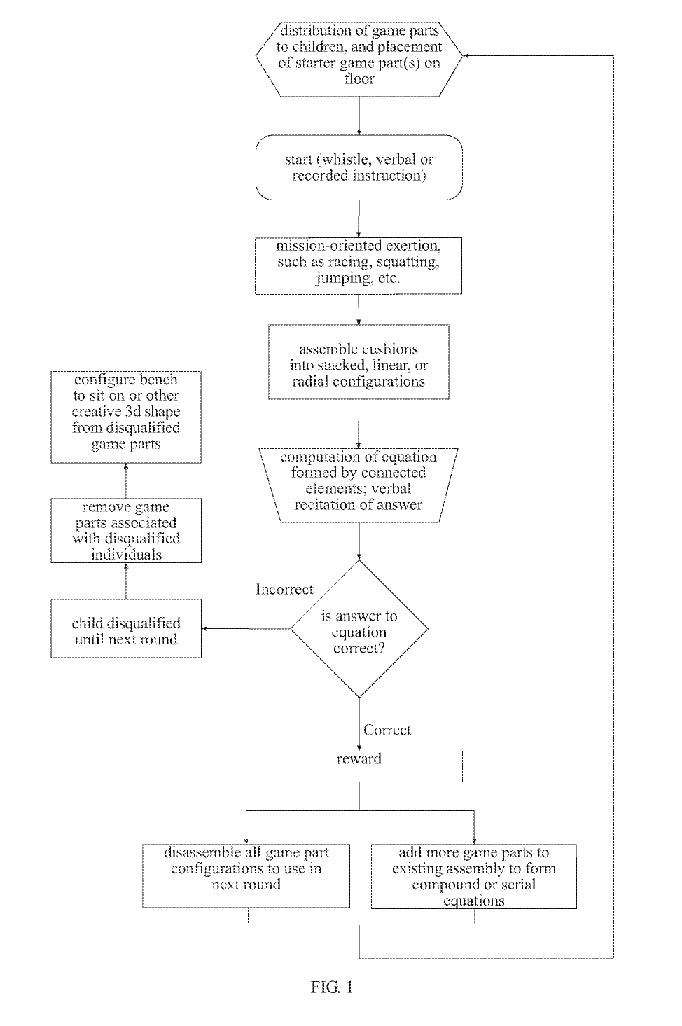

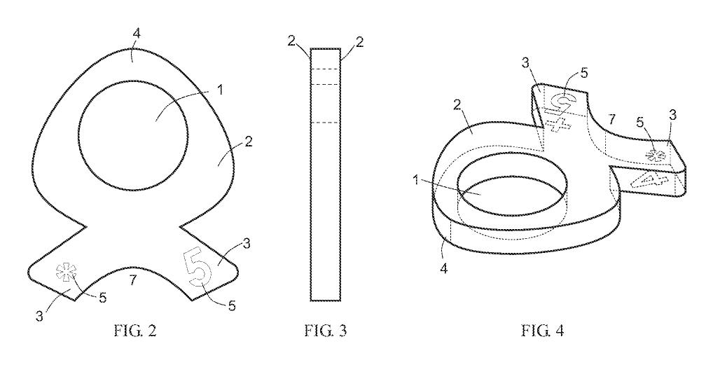

### REFERENCE CITED

U.S. Patent Documents

| | | |
|---|---|---|
| 7,445,285 | November, 2008 | Cohen |
| 20100048356 | February, 2010 | Hamilton |
| 5,370,399 | December, 1994 | Liverance |
| 20060012120 | January, 2006 | Kash |
| 20080138776 | June, 2008 | Zager |
| 7,000,918 | February, 2006 | Tan |
| 5,439,228 | August, 1995 | Pedersen |
| 5,156,409 | October, 1992 | Barnes |
| 7,152,034 | December, 2006 | Layng, et al. |
| 5,098,301 | March, 1992 | Woods |
| 5,868,577 | February, 1999 | Aghevli |
| 7,182,601 | February, 2007 | Donnan |
| 7,104,798 | September, 2006 | Spaventa |
| 7,182,601 | February, 2007 | Donnan |
| 5,507,495 | April, 1996 | Kiss |
| 20080203661 | August, 2008 | Daniels |
| 6,561,514 | May, 2003 | Myles |
| 20020098947 | July, 2002 | Brown |
| 20050112538 | May, 2005 | Pinkins |
| 20080203661 | August, 2008 | Daniels |
| 6,254,101 | July, 2001 | Young |
| 7,488,231 | February, 2009 | Weston |
| 6,682,074 | January, 2004 | Weston |
| 6,967,566 | November, 2005 | Weston, et al. |

### OTHER REFERENCE

Hartmann, Thom. Attention Deficit Disorder: A Different Perception (A Hunter in a Farmer's World). Underwood Books: October 1997. ISBN: 1887424148.

Ledingham, D. Steven. “Best and worst after-school activities for children with ADHD”. Reviewed by the BabyCenter Medical Advisory Board.

http://parentcenterbabycenter.com/0_best-and-worst-after-school-activities-for-children with-adh_{—}67358.pc. 17 Nov. 2008.

“Boy Scout Activities”. http://www.boyscouttrail.com/activities.asp.

Low, Keath. “Understanding Your ADHD Child's Learning Style/Helping Children with ADD or ADHD Learn”. About.com. Updated: Dec. 17, 2008. Source: Rory Stern, PsyD. Personal correspondence/interview. Mar. 25, 2008.

http://add.about.com/od/childrenandteens/a/learningstyles.htm.

“Cranium Hullabaloo”http://www.hasbro.com/games/cranium/browse.cfm?page=&product_=21394.

Magic Carpets. Book of 1000 Family Games, Readers Digest Association, Inc. p. 74, 1971.

Kostelnik, M. J., Soderman, A. K., Whiren, A P. (2004). Developmentally Appropriate Curriculum: Best Practices in Early Childhood Education. 3rd ed. Columbus: Pearson, Merrill Prentice Hall.

“Hyper Dash EXTREME!” Press Release #143 http://www.wildplanet.com/press/wp_release_single.php?prid=143.

“Hyper Dash”. http://www.shopwildplanet.com/prod/WPT46001.html.

### FIELD OF THE INVENTION

The invention generally relates to the fields of games, children's furniture, and children's toys, particularly interactive educational toys. This invention also relates to the field of educational methods for children with special learning styles.

### BACKGROUND AND DESCRIPTION OF THE INVENTION

The inventor suggests that children with kinesthetic and/or visual learning styles cannot effectively learn while in the ergonomic position of sitting in a conventional chair and writing on a desk. Many child psychiatry theories suggest that ADHD spectrum disorders are accompanied by kinesthetic and visual learning styles. It is also commonly accepted today that children with ADHD tend to develop impaired social skills, because of traits such as impulsiveness. It is possible that visual and kinesthetic learning styles observed in ADHD children also differentiate them from the educational norm, auditory learning, thereby creating more difficulties among their peers.

Thomas Hartman similarly describes “hunter” behavior in his writings on hyperactivity. Most Western educational environments teach math through “farmer” methods, as Hartman would describe, passive, auditory, non-social learning. Such learning is embodied by sitting at a desk, listening to auditory explanations and commands, and providing responses in writing directly to the teacher. Such learning precludes peer interaction, physical activity, or visual imagery. Effective auditory learning, however, represents only about 20% of the population, ineffectively addressing visual and kinesthetic learners.

While the prior art addresses these issues, the present invention provides several advantages. Wild Planet Entertainment's toys, “Hyper Dash” and “Extreme Hyper Dash” address the issue of kinesthetic learning. However, the limited number of game parts and prerecorded instructions preclude a large number of action permutations, thereby creating predictability and boredom. These games comprise one control stick, essentially allowing only one child to lead or play at a time. Children may compete buttonly in series, by means of measuring and comparing individual performance time. Patent 20080203661 similarly addresses kinesthetic learning with mission-oriented exercises, but does not offer cooperative problem solving, or infinite action permutations. What is needed is a method and game that allows multiple children to compete and cooperate simultaneously, and that provides for unlimited permutations of problems to solve.

Therefore, what is needed is a method for teaching abstract academic subjects and teaching social skills, in a kinesthetic and/or visual manner. Such a method would ideally include: physical, goal-oriented activity; visual symbols; and social interaction among peers. The educational methods disclosed here attempt to complement hyperactive individuals' need to achieve goals in a competitive setting as well as perception of problems over time and distance.

### SUMMARY OF THE INVENTION

The current application discloses novel methods and games designed to teach math and social skills to children, particularly children with special learning styles.

It is the object of the invention to provide methods and games for teaching math and social skills to children with special learning needs: to provide exercise in a way that is meaningful (e.g., goal-oriented) for hyperactive kids; to create enthusiasm for learning math; to create social interactions among subsets of children within a larger group, thereby improving social skills; to teach computational logic in a visual non-numeric, non-linear, method; to teach flexibility of problem-solving skills; to teach spatial orientation and creative manipulation of the built environment.

The games use mission-oriented physical activity and visual imagery as vehicles for improving math and social skills. The inventor defines mission-oriented exercise as: traveling a distance physiologically from point A to point B, retrieving some data or object from point B, and delivering said data or object by traveling said distance back to “base camp” or point A.

### DETAILED DESCRIPTION OF THE DRAWINGS

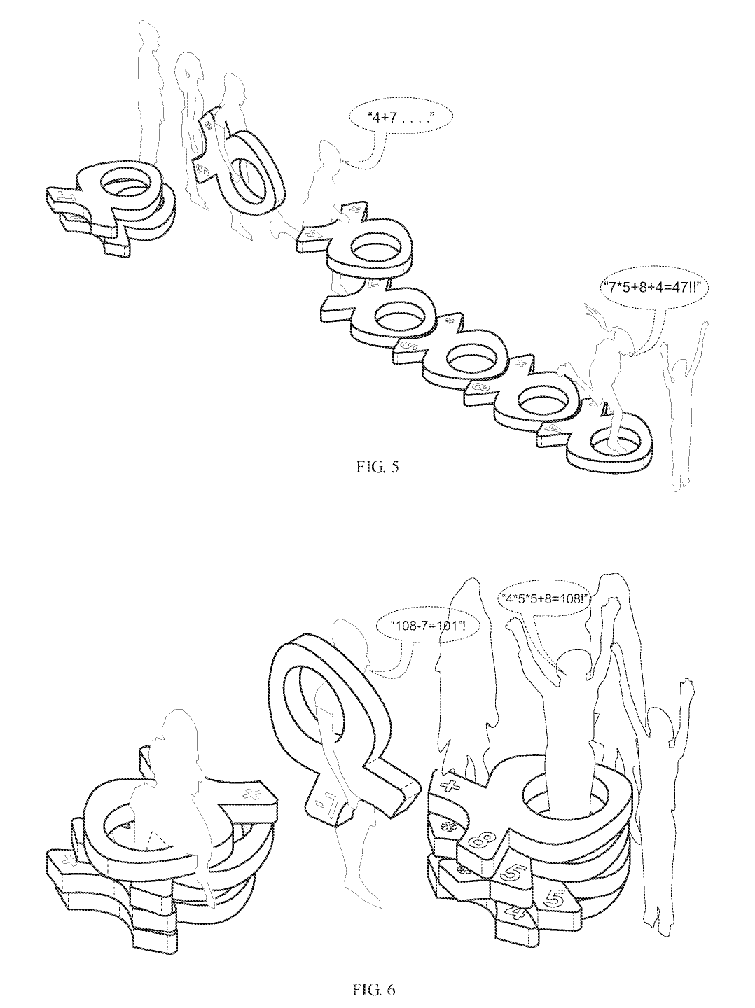

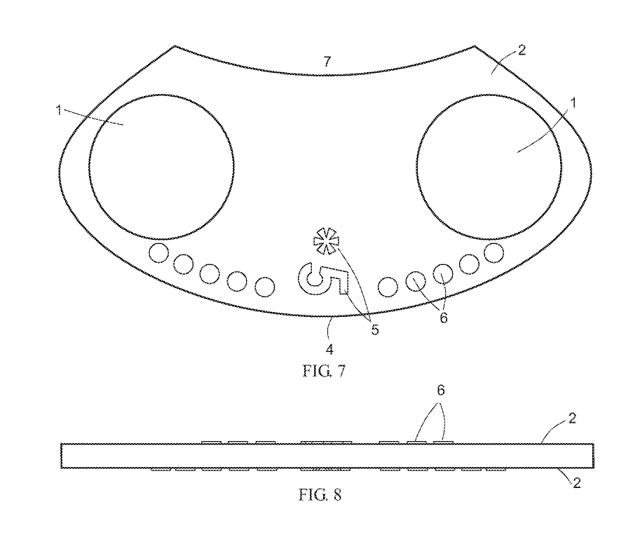

FIGS. 4, 5, and 6 show the preferred embodiment of a game part described in claims 2 and 3. (2) is a flat surface defined by external contours (3) (4) (7) and internal contour (1). (1) is an internal contour defining a window within said flat surfaces (2), described in claim 11. (3) are side protrusions, which may display indicia, (5) such as numbers, letters, actions, or other symbols. Side protrusions (3) may also frame (4) a convex contour (4). Said convex contour (4) is substantially similar in shape to (7), a concave contour. FIG. 7 shows a game, described in claim 2, played with the preferred embodiment of a game part. FIG. 8 shows a game, described in claim 3, played with said preferred embodiment.

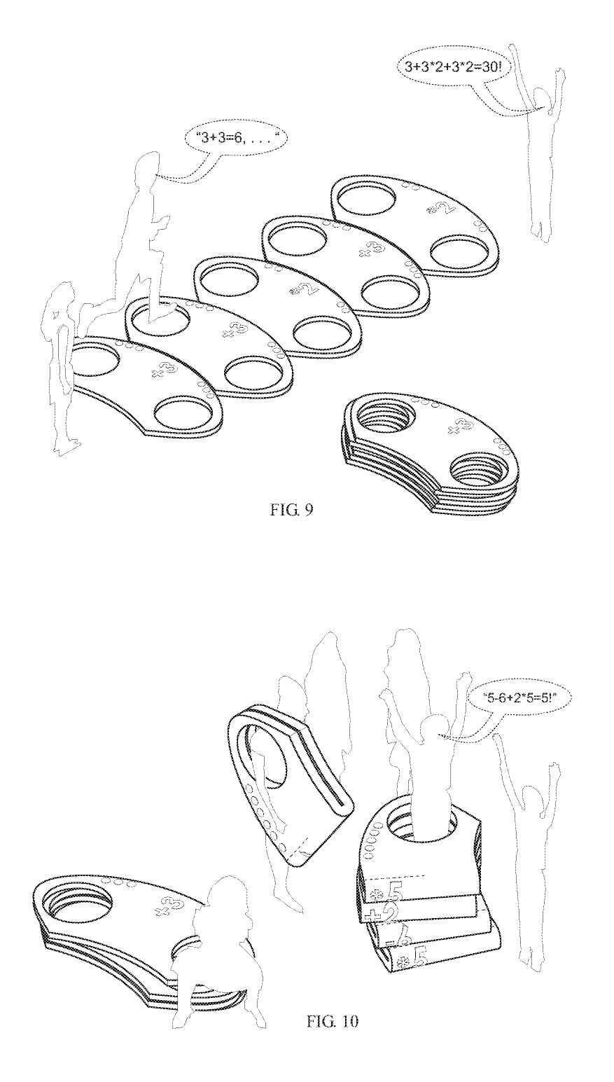

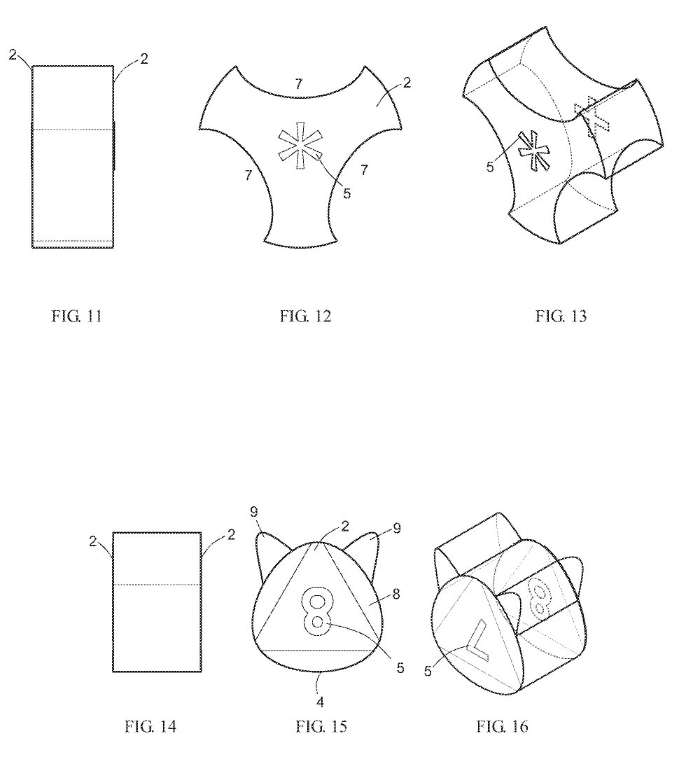

FIGS. 9 and 10 show an alternate embodiment of a game part described in FIGS. 4, 5, and 6, and in claims 2 and 3. (6) are graphic markings, other than numerals, representing numbers. Said graphic markings provide alternative methods of visualizing numbers for children who “read” visually. (1) are a plurality of internal contours, which provide more rigorous physical exercise, similar to jumping though a series a connected tires in military training. FIGS. 11 and 12 show how said embodiment may be used in games described in claims 2 and 3, respectively. Said embodiment may also be folded for playing the game described in claim 3, whereby revealing indicia (5) on the spine created by folding.

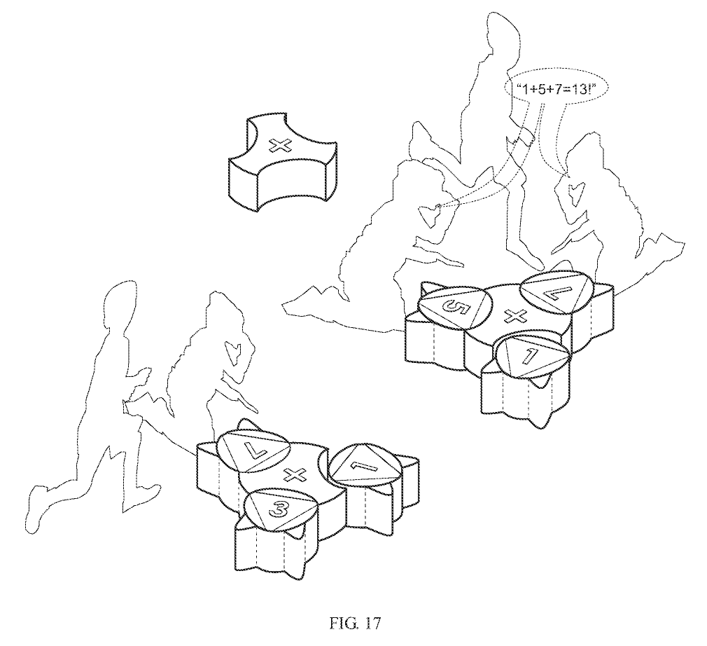

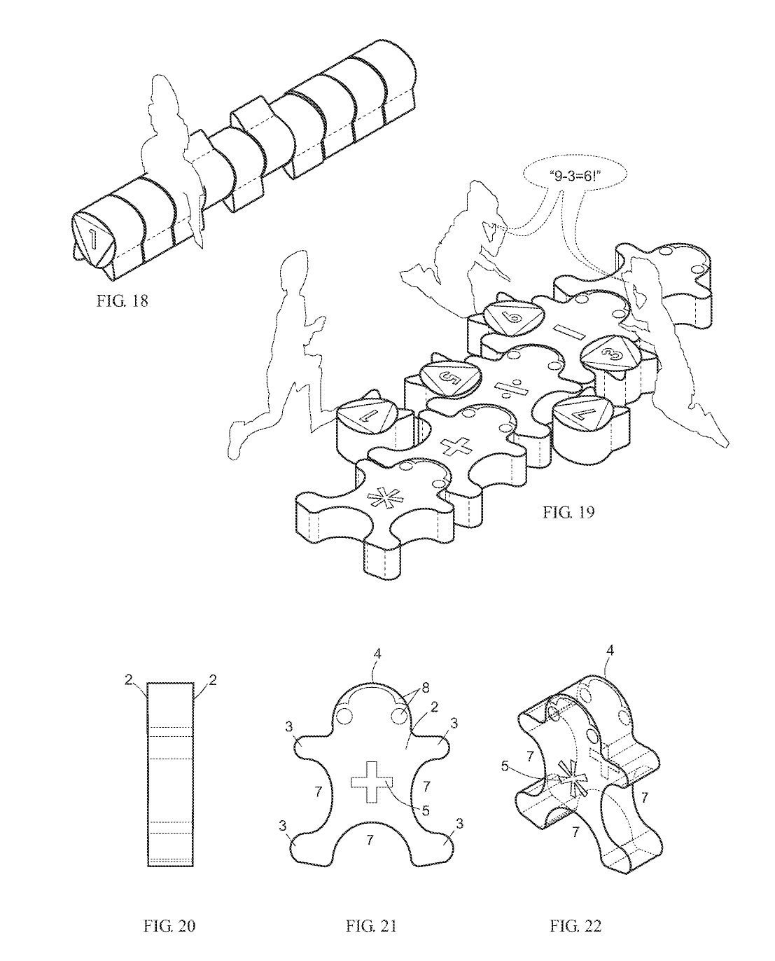

FIGS. 13, 14, and 15 show radial game parts described in claim 4, comprising parallel flat surfaces (2), a plurality of concave contours (7) arrayed in a polar array, and indicia (5) displayed on both flat surfaces (2). FIGS. 16, 17, and 18 shows satellite game parts, described in claim 3. Said satellite game parts comprise parallel flat surfaces (2), a convex contour (4), indicia (5) displayed on both flat surfaces (2), and a plurality of protrusions (9), which may be used for grasping, or describing zoomorphic features such as ears. (8) are graphic markings designating zoomorphic or anthropomorphic features, such as eyes or hair. Zoomorphism may help children to empathize with the game and therefore create enthusiasm for learning math. FIG. 19 shows a game, described in claim 4, using said radial and satellite parts shown in FIGS. 13-18.

FIG. 21 shows a game described in claim 5, using said satellite parts shows in FIGS. 16-18, and rectilinear parts described in claim 5 and FIGS. 22-24. FIG. 20 shows a bench created by connecting the flat faces (2) of said satellite parts, by means of fasteners (8). Children who have left a game may watch the rest of the game while sitting on said bench, or may continue to play by reconfiguring the extra satellite parts into other creative configurations.

What is claimed:

1. An educational method for developing cognitive and social skills in children, particularly children with special learning needs; wherein children are distributed physical embodiments of a number, action, letter, or combination of indicia; whereby children assemble said embodiments into linear, curvilinear, radial, or stacked configurations to display permutations of equations for solving; whereby the assembly and disassembly of said physical embodiments requires competitive, mission-oriented physical exercise; whereby said juxtaposition of game parts creates random and changing sub-groups of children, and hence creating social interactions, and requiring cooperation to solve said permutations; wherein rewards are performance-based and public.

2. A game embodying the method of claim 1, comprising the steps of: distributing substantially similar game parts to a group of children, one per child; said game parts displaying indicia such as numerals and actions; the children forming a line; placing one spare game part on the floor at the front of the line; the first child in the line stepping through or over said spare game part; then reciting the indicia displayed thereof; then configuring the game part s/he is holding on the floor in series with the spare game part; then reciting and calculating the action displayed by the two sequential game parts; then receiving feedback for his/her answer; wherein for a correct answer the child stepping through or over the his/her [second] game part and leaving the game; wherein for an incorrect answer the child calculates the action again until correct, or alternatively leaves the game; the next child in line repeating the previous steps, calculating the compound action displayed by three sequential game parts; and so on, until all the children in the line have configured and calculated their game part in series.

3. An alternate method of playing the of the game of claim 2, comprising the steps of: children forming a circle around one child; one child in the circle stacking his/her game part on the center child's game part; the center child reciting the action composed from the sequence of said two stacked game parts; the center child solving the equation verbally; whereby the center child providing a correct answer starts another round; whereby providing an incorrect answer ends his/her turn in the center and s/he exchanges position with another child in the circle; the steps repeating until all the children in the circle have stacked their cushions in the center and a compound equation of all stacked cushions has been recited and solved.

4. An alternate game embodying the method of claim 1, comprising the steps of: distributing throughout a defined space X number of substantially similar radial game parts; said radial game parts having a substantially circular contour, and displaying indicia, and having Y number of concave docking stations in a polar array; distributing Y+1 number of substantially similar satellite game parts to Y+1 number of children; wherein said Y said satellite parts having indicia and convex docking elements; wherein said convex docking elements correspond in shape to said concave docking stations; a signal starting a game round; children racing to a squat at and temporarily filling a docking station; the extra child or children, not grabbing a spot at a docking station, leaving the game, similar to the process of elimination of “Musical Chairs”;
forming impromptu sub-groups of children at each docking station, cooperating to solve a problem; squatting children connecting respective sub-parts to docking parts; the combination of indicia of said radial docking part and said satellite parts forming an equation to be solved; sub-groups of children collectively reciting said equation and its answer; sub-groups of children with incorrect answers leaving the game, and sub-groups of children with correct answers continuing to the next round; alternatively all children continuing to the next round, yet removing the docking stations associated with incorrect answers; whereby the last impromptu sub-group to recite a correct answer wins the game.

5. An alternate embodiment of the game of claim 4, comprising substantially similar steps and parts except for: assembling X-number of game parts in a linear or curvilinear series; said game parts having an overall rectilinear contour, and having concave docking stations arrayed along the sides of said rectilinear contour; and distributing said satellite game parts of claims 4 to 2X+1 number of children, whereby allowing process of elimination among children.

6. The indicia of claims 1, 2, 3, 4, and 5 comprise a numeral, and/or a symbol of a number, and/or an action such as + − *, and/or a letter, and/or a word, and/or a pictogram, and/or another symbol.

7. The game parts of claims 1, 2, 3, 4, and 5, having dimensions significant to a child's body;
whereby allowing physical challenges such as jumping over, etc.

8. The game parts of claims 1, 2, 3, 4, and 5, having a flat top surface and a parallel flat bottom surface, with each face displaying a different set of indicia, thereby allowing a child to choose with which indicia s/he prefers to work during a round of a game.

9. The game parts of claims 1, 2, 3, 4, and 5, having a series of contours defining the edges of said flat surfaces, including a convex contour at one end, a substantially similar concave contour at the opposite end, whereby allowing substantially similar parts to be connected in series in a male-female manner.

10. The game parts of claims 1, 2, 3, 4, and 5, having side protrusions, whereby framing said concave contour, and/or providing substantially separate platforms for displaying separate indicia, and/or acting as handles for grasping said part while running.

11. The game parts of claims 4 and 5, comprising one or more hollow extruded cuts, of dimensions significant to a child's body, whereby allowing a child to jump through, stand in, or thread an arm through to hold said game part; whereby allowing said game parts to be stacked concentrically, whereby allowing a child to stand within the hollow cylinder formed wherein.

12. The game elements of claims 1, 2, 3, 4, and 5, having a pliable cushion base, and having a removable fabric exterior cover, onto which indicia may be permanently adhered or printed.

13. The indicia of claim 12 manufactured from a fastening material, such as “Velcro”, whereby allowing game parts to be connected into forms such as a bench, or other three-dimensional creative shapes.

14. The game elements of claims 1, 2, 3, 4, and 5, having a rigid plastic construction, and having substantially smaller dimensions, whereby allowing the game to be packaged into a board game box.

15. The game elements of claims 1, 2, 3, 4, and 5, displaying changing indicia by means of an electronic display.

16. The games of claims 1, 2, 3, 4, and 5, whereby the game is started, answers are evaluated, and feedback is relayed, by means of an electro-mechanical apparatus embedded in said plastic construction.
